(19) United States
(12) Patent Application Publication
(10) Pub. No.: US 2015/0143451 A1
(43) Pub. Date: May 21, 2015

(54) Safety in Downloadable Applications for Onboard Computers

(71) Applicant: Cisco Technology Inc., San Jose, CA (US)

(72) Inventors: Hillel Solow, Beit Shemesh (IL); Lawrence Sol Rublin, Beit Shemesh (IL)

(21) Appl. No.: 14/083,807

(22) Filed: Nov. 19, 2013

(51) Int. Cl. H04L 29/06; H04L 29/08

(52) U.S. Cl. CPC H04L 63/20; H04L 67/12; H04L 67/18
USPC 726/1

(57) ABSTRACT

A method for providing safety for downloadable applications on an onboard computer in a safety critical environment includes installing an application on the onboard computer, where the application is signed by a trusted signing entity, associating a usage policy with the signed application in a safety permissions manifest, where the usage policy at least includes rules for actions allowed for the signed application under certain environmental conditions in the safety critical environment, monitoring the environmental conditions, receiving a request to perform an action from the signed application, determining whether performance of the action is permissible, where the determining is based on least on the associated usage policy and the monitored environmental conditions, and permitting/preventing the performance based on the determining. Related apparatus and methods are also described.

### FIELD OF THE INVENTION

The present invention relates to downloadable applications for onboard computers in general, and particularly, but not exclusively, to safety issues arising from their operation in a safety critical environment.

### BACKGROUND OF THE INVENTION

The following references are believed to represent the state of the art:

U.S. Pat. No. 6,188,315B1, “Situational feature suppression system” to Martin John Herbert; and

U.S. Pat. No. 5,949,345, “Displaying computer information to a driver of a vehicle” to Richard D. Beckert.

### SUMMARY OF THE INVENTION

The present invention, in certain embodiments thereof, seeks to provide a system and method for improving the safety of installed applications in safety critical environments.

There is thus provided in accordance with an embodiment of the present invention a method for providing safety for downloadable applications on an onboard computer in a safety critical environment, the method including installing an application on the onboard computer, where the application is signed by a trusted signing entity, associating a usage policy with the signed application in a safety permissions manifest, where the usage policy at least includes rules for actions allowed for the signed application under certain environmental conditions in the safety critical environment, monitoring the environmental conditions, receiving a request to perform an action from the signed application, determining whether performance of the action is permissible, where the determining is based on least on the associated usage policy and the monitored environmental conditions, and permitting/preventing the performance based on the determining.

Further, in accordance with an embodiment of the present invention, the usage policy is signed by the signing entity.

Still further, in accordance with an embodiment of the present invention, the associating includes associating a default usage policy with the signed application in accordance with an application type.

Additionally, in accordance with an embodiment of the present invention, the safety critical environment is an automobile.

Moreover, in accordance with an embodiment of the present invention, the certain environmental conditions include actions performed by other signed applications installed in the safety critical environment.

Further, in accordance with an embodiment of the present invention, the monitoring includes receiving input from electronic control units (ECUs).

Still further, in accordance with an embodiment of the present invention, the certain environmental conditions comprise at least one of: speed, direction, location, road type, speed limit, tire angle, time of day, lighting conditions, road conditions, doors open/closed and cruise control.

Additionally, in accordance with an embodiment of the present invention, the permitting/preventing includes at least one of: permitting, preventing, and temporarily preventing.

Moreover, in accordance with an embodiment of the present invention, the associating includes: defining environmental profiles based on at least two of the environmental conditions.

Further, in accordance with an embodiment of the present invention, the monitoring includes monitoring over a defined period of time.

Still further, in accordance with an embodiment of the present invention, the application is a third party applications provided by sources external to the provider of the safety critical environment.

There is also provided a system for providing safety for downloadable applications on an onboard computer in a safety critical environment, the system including means for installing an application on the onboard computer, where the application is signed by a trusted signing entity, means for associating a usage policy with the signed application in a safety permissions manifest, where the usage policy at least includes rules for actions allowed for the signed application under certain environmental conditions in the safety critical environment, means for monitoring the environmental conditions, means for receiving a request to perform an action from the signed application, means for determining whether performance of the action is permissible, where the determining is based on least on the associated usage policy and the monitored environmental conditions, and means for permitting/preventing the performance based on the determining.

There is also provided a system for providing safety for downloadable applications in a safety critical environment, the system including an operating system installed on an onboard computer configured to control and operate at least some components of the safety critical environment, where the operating system is configured to facilitate installation of at least one signed application configured to execute in the safety critical environment, a safety permissions manifest comprising at least usage rules, where the usage rules define environmental conditions under which certain functionalities of the components are permitted to be used by the at least one signed application, at least one environmental indicator configured to provide indications about the safety critical environment, and a safety status monitor configured to at least use the indications to evaluate functionality requests received from the at least one signed application according to the usage rules.

### BRIEF DESCRIPTION OF THE DRAWINGS

The present invention will be understood and appreciated more fully from the following detailed description, taken in conjunction with the drawings in which:

FIG. 1 is a schematic illustration of an application security system for onboard computers in a safety critical environment, constructed and operative in accordance with an embodiment of the present invention,

FIG. 2 is a schematic illustration of an exemplary environmental profile table, constructed and operative for use with the system of FIG. 1, and

FIG. 3 is a schematic illustration of an exemplary safety permission manifest of the system of FIG. 1.

### DETAILED DESCRIPTION OF AN EMBODIMENT

As CPU capabilities for infotainment and other devices in automobiles improve, car manufacturers may attempt to add value and increase revenue by enabling users to purchase and/or download applications for execution on the car CPUs. Such applications may include, for example, navigation applications, entertainment applications, applications that provide information about the drive and the surroundings, productivity applications, and more.

As with a non-automotive application store environment, applications would typically be signed, such that the manufacturer or some other third party could maintain tight control over which applications are executed on the car. With a non-automotive application store, the motivation for this is typically twofold: to prevent the inadvertent execution of malicious software on a device, and to prevent users from circumventing payment for the applications they run.

In an automotive environment (as well as other safety critical environments, such as airplanes, military equipment, medical equipment, etc.) there is a further concern that applications may distract or otherwise negatively impact the performance of the driver. Thus, in addition to typical restrictions such as which applications may be executed, and what resources an application may be trusted to use, the Inventors have realized that an additional layer of safety rules may be required to ensure maximum safety while still providing a rich application ecosystem.

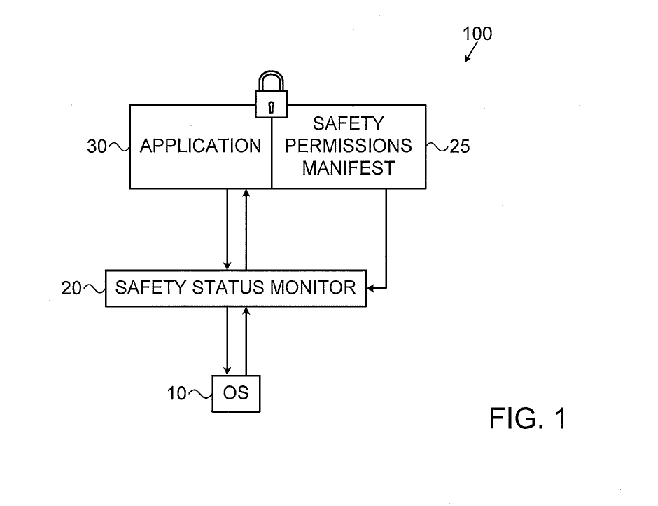

Reference is now made to FIG. 1 which illustrates an exemplary application security system 100 for onboard computers in a safety critical environment, constructed and operative in accordance with a preferred embodiment of the present invention. System 100 may, for example, be integrated as part of an automobile's onboard computer system. It will, however, be appreciated that system 100 may alternatively be implemented in other safety critical environments as well, for example, airplanes, military equipment, medical equipment, etc.

Application security system 100 comprises operating system 10, safety status monitor 20, safety permissions manifest 25 and application 30. It will be appreciated that system 100 is typically configured with storage media and processing means (such as a computer processor or microprocessor) to store and facilitate the use of these elements. It will also be appreciated that system 100 may comprise more than one application 30; FIG. 1 depicts only one application 30 in the interests of clarity. Safety status monitor 20 is configured to monitor safety status indicators for the environment in which system 100 is installed, and to determine the extent to which applications 30 may operate in light of their impact on the monitored safety status. Operating system 10 is typically implemented as the operating system for an onboard computer, such as may be used to control at least some of the operations of an automobile. As configured in system 100, safety status monitor 20 is employed by operating system 10 to monitor the status of various elements of a safety critical environment such as, for example, an automobile. Safety status monitor 20 may allow/restrict actions by applications 30 in accordance with the monitored status.

Safety permissions manifest 25 comprises sets of usage policies that may be used by safety status monitor 20 to determine under which circumstances applications 30 may be permitted to perform specific actions. Each set of usage policies comprises the safety rules which safety status monitor 20 enforces for system 100, and may be cryptographically bound to the associated application 30.

For example, a typical application 30 in a vehicular environment may be a navigation system. A usage policy for a vehicular navigation application may comprise rules such as:

Application 30 is allowed to access GPS hardware,

Application 30 is allowed to use audio speakers,

Application 30 is allowed to use voice input,

Application 30 is allowed to use touch screen input, but only when the vehicle is stationary or its speed is below a defined threshold, and

Application 30 is allowed to access steering wheel buttons, but only when the wheel angle is less than a defined threshold, e.g. when a car is not changing lanes.

It will be appreciated that such a usage policy may generally promote driver safety and hopefully prevent accidents that may otherwise occur in the absence of restrictions on the operation of installed applications. Per the example, by enforcing such a usage policy, drivers may be discouraged from removing their hands from the steering wheel while the car is in motion. The usage policy may also promote more careful driving when switching lanes.

It will also be appreciated that applications 30 may be third party applications that are provided by sources external to the provider of system 100. As discussed hereinabove such applications may be signed by a trusted signing entity as a precondition for installation in use with system 100. The signing process may also include validation and/or signing of a usage policy for the application.

Operating system 10 comprises a set of application programming interface (API) calls that may be required in the development of applications as a prerequisite for signing. The API calls facilitate the routing of requests for certain functionalities in applications 30 through safety status monitor 20 before the functionalities may be executed by operating system 10. If the API calls are not used as required by an application, the signing entity may not sign the application and it may not be installed in system 100. It will be appreciated that there may be other criteria for whether or not the signing entity signs a given application.

When an application 30 is installed in system 100, its associated usage policy may be entered into safety permissions manifest 25 to be accessed as necessary by safety status monitor 20 to determine what actions the associated application 30 may or may not perform when running in system 100. Alternatively, safety permissions manifest 25 may be configured with a default usage policy for a given type of application. For example, a default usage policy may be defined for all navigation applications, a different default usage policy may be defined for browser applications, and so on. System 100 may be configured to use such default usage policies in the absence of, or even instead of, an associated usage policy for a given application 30.

In operation, safety status monitor 20 maintains and enforces each of the application usage policies in system 100. It will be appreciated that safety status monitor 20 is configured to receive periodic and/or continuous updates regarding the prevailing environmental conditions for system 100. For example, if system 100 is integrated in an automotive environment, it will be appreciated that the environment may be subject to frequent change as the automobile starts, accelerates, slows, turns, stops, reverses, etc. Safety status monitor 20 may be configured to receive updates regarding environmental conditions from the automobile's installed electronic control units (ECUs) or any other suitable means. Each request by application 30 may then be evaluated vis-à-vis both its associated usage policy in safety permissions manifest 25 and the current conditions to determine how the operating system 10 should respond to the request.

Table 1, shown hereinbelow comprises a non-limiting list of exemplary environmental conditions suitable for an automotive environment.
Speed
Direction
Location (longitude/latitude, or city/highway)
Road type
Speed limit
Turn signal
Hazard lights
Time of day
Lighting conditions
Doors open/closed
Cruise control
Brakes
Parking brake
Seat belts
Transmission gear

Table 1.

Some of these environmental conditions may be directly monitored by an automobile's onboard computer and/or installed ECUs. For example, the monitoring of time of day, speed, brakes, seat belts, cruise control, transmission gear and doors open/closed are common features generally available in most automobiles. Other conditions such as direction, location, road type and speed limit may be tracked in coordination with external input, typically from GPS, mapping and/or navigation services. Such services may be provided via manufacturer installed integrated components or via applications 30 in system 100.

Responses by operating system 10 may include, for example:

Reject request: For example, application 30 may request to play a sound. The environmental conditions as reported to safety status monitor 20 may indicate that the transmission gear of the automobile in which system 100 is installed may be in reverse. In such a case, the usage policy may prohibit sound requests which may distract the driver when the automobile is set to move in reverse, operating system 10 may reject the request.

Defer request: a usage policy may also indicate that a request may be deferred until a given condition may be met. For example, if the automobile's gear is detected as being in reverse as per the example hereinabove, the request to play a sound may not be rejected outright; instead the request may be deferred until the gear is shifted. For example, operating system 10 may allow the sound to play after safety status monitor 20 is informed that the transmission gear has been moved to a different gear, such as, for example, first or second gear.

Allow request: If the associated usage policy indicates that the request is permissible under the currently reported environmental conditions as known to safety status monitor 20, operating system 100 may allow the request.

The environmental conditions listed hereinabove may generally be measured in an objective manner. For example, an automobile's odometer provides a reasonably reliable measure of speed, doors are either open or closed, optical sensors may provide an indication of lighting conditions, transmissions have a finite and known number of gear settings, turn signals and hazard lights are either on or off, and cruise control, brakes, parking brakes and seat belts are either engaged or not. Similarly, direction, location, road type and speed limit as reported by an external service may be expressed quantifiably.

However, some environmental conditions may require subjective analysis. For example, road conditions and driver fatigue/alertness may be less easily quantified. It will be appreciated that safety status monitor 20 may be unable to ascertain road conditions based on input received from any single source at a specific time. However, repeated shifting of gears, steering wheel adjustments and use of brakes, either singly or in combination, over time may indicate that the automobile is being driven through difficult road conditions. Similarly, driver fatigue may be indicated subjectively by a combination of input factors such as length of time since the automobile was started and recurring sudden stops and sharp steering wheel adjustments over time.

Other conditions may be determined according to both subjective and objective analysis. For example, whereas an automobile's tire angle may generally provide an objective indication of a vehicle turning, activation of a turn signal and/or feedback from a navigation application may provide a similar indication or even indicate the expectation of such a turn before it actually happens. Therefore, in some cases even though from an objective standpoint an automobile may not actually be turning (e.g. the reported tire angle indicates that the automobile is heading straight), if the turn signal is on and/or a navigation route shows an imminent turn, it may nevertheless be assumed that the automobile is in a turning state.

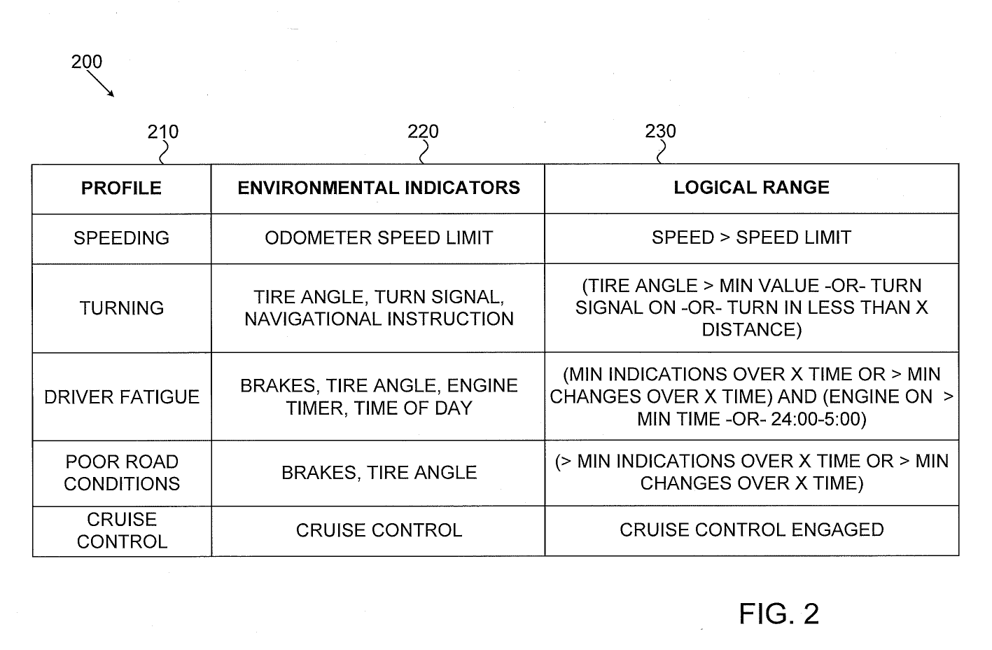

In accordance with some embodiments of the present invention, usage policies may be defined in safety permissions manifest 25 for environmental profiles. An environmental profile comprises one or more objective environmental conditions, such as, for example, the environmental conditions listed in FIG. 2. Reference is now made to FIG. 2, which depicts an exemplary environmental profile table 200, constructed and operative in accordance with embodiments of the present invention. Table 200 comprises profiles 210, environmental indicators 220 and logical ranges 230. Environmental indicators 220 indicate sources of objective conditions that may be received by safety status monitor 20 from installed monitoring systems and/or applications 30. Table 1 may provide an exemplary listing of such sources.

For each profile 210 there is one or more associated environmental indicators 220 that may be used by safety status monitor 20 to ascertain whether or not profile 210 may be relevant for the current driving environment. For example, for a profile 210 of “speeding”, environmental indicators 220 may be the odometer and the speed limit as received via a GPS/mapping system. The associated logical range 230 indicates that if the speed reported by the odometer exceeds the speed limit reported by the GPS/mapping system, then safety status monitor 20 may determine that the speeding profile is relevant for the current driving environment.

Some profiles 210 may be determined according to more complex logical ranges 230 for multiple environmental indicators 220. For example, “turning” may be determined according to tire angle exceeding a minimum value, a turn signal being engaged, or a turn instruction received from an application 30 such as, for example, a GPS/mapping application. Any single one of these environmental conditions 220 in the appropriate logical range 230 may be sufficient to determine that an automobile is turning. A profile 210 for poor road conditions may be determined according to environmental indicators 220 such as brakes and tire angle. Repeated application of an automobile's brakes and/or repeated adjustment of tire angle may indicate that an automobile is experiencing poor road conditions.

Some profiles 210 may require a combination of environmental indicators 220 to be within logical ranges 230. For example, while as per the abovementioned example, brakes and tire angle may indicate poor road conditions, under certain circumstances they may also indicate driver fatigue. Sometimes as tired drivers start falling asleep, they may repeatedly jerk the steering wheel in an effort to stay in their lane, and/or repeatedly apply their brakes. Additional environmental indicators 220 such as an engine timer and/or a time of day clock may help determine that what may appear to be poor road conditions, may in fact be driver fatigue. For example, if the engine has been running for several hours or if the time of day is some time in the middle of the night (for example, midnight to 5:00 AM), then safety status monitor 20 may determine that the driver is fatigued.

It will be appreciated that as per the examples hereinabove, safety status monitor 20 may consider environmental indicators 220 provided by currently running applications 30 when evaluating the current environmental indicators. For example, application 30 may request to play a sound, as per one of the previously discussed examples. In such a scenario, application 30 may be, for example, an interactive trivia game or media player. As per the previous discussion, in order to determine whether or not to allow the request, safety status monitor 20 may consider current wheel angle in order to verify whether or not the automobile is turning. Such information may typically be available from an ECU controlling the automobile's wheels. However, other applications 30 that may be running in parallel may also provide information indicative of whether an automobile is turning or is about to turn. For example, a navigational application may update safety status monitor 20 that the automobile is turning or is scheduled to turn in the near future. Such information may also be used by safety status monitor 20 when determining the current environmental profile 210 to be used when evaluating the request from the first application 30.

It will also be appreciated that more than one environmental profile 210 may be current in parallel. For example, per the examples in table 100, speeding and cruise control are not necessarily mutually exclusive environmental profiles; an automobile may be on cruise control and speeding at the same time. Similarly, in cases where an environmental indicator 220 may apply to multiple profiles 210, system 100 may be configured to use the environmental indicator 220 to determine that multiple profiles 210 are current. For example, per the discussion hereinabove, safety status monitor 20 may determine that profiles 210 for both poor road conditions and driver fatigue are concurrent.

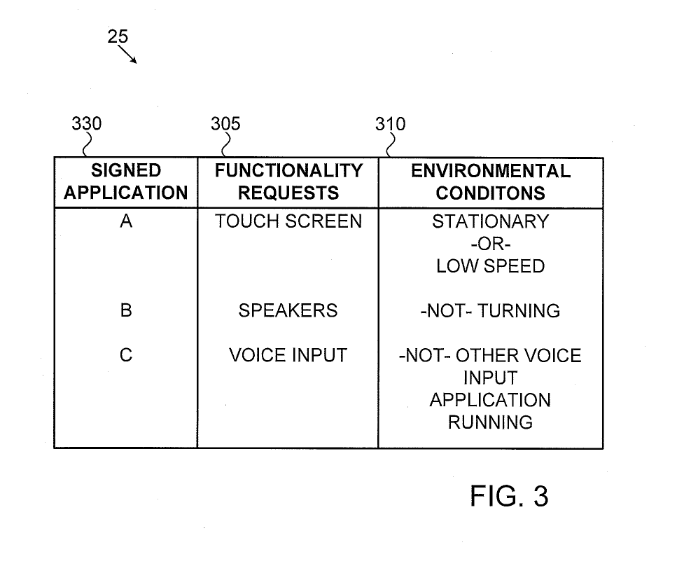

It will also be appreciated that it may be unwieldy to define individual usage policies for functionality requests in safety permissions manifest 25 according to environmental indicators 220, instead, usage policies may be defined according to environmental profiles 210. Reference is now made to FIG. 3 which depicts an exemplary safety permissions manifest 25, constructed and operative in accordance with embodiments of the present invention. Functionality requests 305 represent requests that may be received from installed applications 330 and environmental conditions 310 represent environmental conditions that may be prerequisites for safety status monitor 20 to grant requests 305.

Environmental conditions 310 may be defined in terms of one or more environmental profiles 210. For example, in order for signed application 330A to use a touch screen (functionality request 305), safety status monitor may have to determine that the current environmental profiles 210 include at least “stationary” or low speed”. It will be appreciated that such profiles 210 are defined as discussed hereinabove in table 200.

Environmental conditions 310 may also be defined in negative terms. For example, signed application 330B may only use the speakers if the automobile is not turning. Environmental conditions 310 may also relate to other applications 30. For example, if signed application 330C requests to use voice input, it may be precluded from doing so if another application 30 is already using the same functionality.

It will be appreciated that the configuration of safety permissions manifest 25 as depicted may be exemplary, there may, for example, be instances where no environmental conditions 310 may preclude granting requests 305. The entry for signed application 330 may be optional in some configurations. Some, or all, usage rules for functionality requests 305 may therefore be generic without being limited to a specific application 330. Manifest 25 may also be configured alternatively, such that usage rules may be associated with types of signed applications 30 as opposed to specific signed applications 330. For example, as depicted, signed application 330A may be a specific GPS/navigation application. Manifest 25 may alternatively be configured such that signed application 330A may refer to a type of signed application, e.g. all GPS/navigation applications. As discussed hereinabove, system 100 may also be installed in non-automotive safety critical environments, such as, for example, airplanes, military equipment, medical equipment, etc. Environmental conditions that may typically be monitored in an aircraft that may also be used by safety status monitor 20 in an airplane environment may include, for example: air speed, wind speed, compass direction, location, altitude, destination, attitude (i.e. angle of ascent or descent), visibility, time of day, wheel position (i.e. locked, extended), fuel level, internal air pressure, wing flap position, gate connection, autopilot, internal/external temperature, etc. It will be appreciated that commercial aircraft are typically configured with inflight entertainment systems whose operation may be controlled by system 100 in the interests of safety depending on environmental conditions.

It will therefore be appreciated that system 100 may be implemented in an aircraft or automobile to safely control applications 30 in light of environmental conditions. System 100 may also safely control the interaction between the various software systems required to fly a modern aircraft and/or to drive an automobile. It will be appreciated that system 100 may be employed in military and/or medical equipment with similar benefits, leveraging the existence of environmental condition sensors to determine whether or not installed applications may perform specific actions.

In practice, some or all of these functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to system 100 in electronic form, over a network, for example. Alternatively or additionally, the software may be stored in tangible, non-transitory computer-readable storage media, such as optical, magnetic, or electronic memory.

It is appreciated that software components of the present invention may, if desired, be implemented in ROM (read only memory) form. The software components may, generally, be implemented in hardware, if desired, using conventional techniques. It is further appreciated that the software components may be instantiated, for example, as a computer program product, on a tangible medium, or as a signal interpretable by an appropriate computer.

It will be appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

It will be appreciated by persons skilled in the art that the present invention is not limited by what has been particularly shown and described hereinabove. Rather the scope of the invention is defined by the appended claims and equivalents thereof.

What is claimed is:

1. A method for providing safety for downloadable applications on an onboard computer in a safety critical environment, the method comprising:
installing an application on said onboard computer, wherein said application is signed by a trusted signing entity,
associating a usage policy with said signed application in a safety permissions manifest, wherein said usage policy at least comprises rules for actions allowed for said signed application under certain environmental conditions in said safety critical environment,
monitoring said environmental conditions,
receiving a request to perform an action from said signed application,
determining whether performance of said action is permissible, wherein said determining is based on least on said associated usage policy and said monitored environmental conditions, and
permitting/preventing said performance based on said determining.

2. The method according to claim 1 and wherein said usage policy is signed by said signing entity.

3. The method according to claim 1 and wherein said associating comprises associating a default usage policy with said signed application in accordance with an application type.

4. The method according to claim 1 and wherein said safety critical environment is an automobile.

5. The method according to claim 1 and wherein said certain environmental conditions comprises actions performed by other signed applications installed in said safety critical environment.

6. The method according to claim 1 and wherein said monitoring comprises receiving input from electronic control units (ECUs).

7. The method according to claim 1 and wherein said certain environmental conditions comprise at least one of: speed, direction, location, road type, speed limit, tire angle, time of day, lighting conditions, road conditions, doors open/closed and cruise control.

8. The method according to claim 1 and wherein said permitting/preventing comprises at least one of: permitting, preventing, and temporarily preventing.

9. The method according to claim 1 and wherein said associating comprises: defining environmental profiles based on at least two of said environmental conditions.

10. The method according to claim 1 and wherein said monitoring comprises monitoring over a defined period of time.

11. The method according to claim 1 and wherein said application is a third party application provided by sources external to the provider of the safety critical environment.

12. A system for providing safety for downloadable applications on an onboard computer in a safety critical environment, the system comprising:
means for installing an application on said onboard computer, wherein said application is signed by a trusted signing entity,
means for associating a usage policy with said signed application in a safety permissions manifest, wherein said usage policy at least comprises rules for actions allowed for said signed application under certain environmental conditions in said safety critical environment,
means for monitoring said environmental conditions,
means for receiving a request to perform an action from said signed application,
means for determining whether performance of said action is permissible, wherein said determining is based on least on said associated usage policy and said monitored environmental conditions, and
means for permitting/preventing said performance based on said determining.

13. A system for providing safety for downloadable applications in a safety critical environment, the system comprising:
an operating system installed on an onboard computer configured to control and operate at least some components of said safety critical environment, wherein said operating system is configured to facilitate installation of at least one signed application configured to execute in said safety critical environment,
a safety permissions manifest comprising at least usage rules, wherein said usage rules define environmental conditions under which certain functionalities of said components are permitted to be used by said at least one signed application,
at least one environmental indicator configured to provide indications about said safety critical environment, and
a safety status monitor configured to at least use said indications to evaluate functionality requests received from said at least one signed application according to said usage rules.
